(19) United States
(12) Patent Application Publication
(10) Pub. No.: US 2021/0389708 A1
(43) Pub. Date: Dec. 16, 2021

(54) FIXING DEVICE AND IMAGE FORMING APPATARUS INCLUDING THE FIXING DEVICE

(71) Applicant: KYOCERA Document Solutions Inc., Osaka (JP)

(72) Inventors: Akihiro KONDO, Osaka-shi (JP); Takeru YOSHIDA, Osaka-shi (JP)

(73) Assignee: KYOCERA Document Solutions Inc., Osaka (JP)

(21) Appl. No.: 17/342,654

(22) Filed: Jun. 9, 2021

(30) Foreign Application Priority Data
Jun. 15, 2020 (JP) 2020-102825

(51) Int. Cl. G03G 15/20; G03G 15/00

(52) U.S. Cl. CPC G03G 15/2053; G03G 2215/2038; G03G 15/2064; G03G 15/5008

(57) ABSTRACT

A fixing device includes a heated rotational body, a heating unit, a pressing rotational body, a pressing mechanism, a drive unit, a position recognition part, a rotational state determination part, a drive control part, and a pressing control part. The heated rotational body has a pattern. The position recognition part is configured to recognize a specific point contained in the pattern at a prescribed period. The rotational state determination part is configured to determine a variation in a rotational speed of the heated rotational body and a meandering state of the heated rotational body based on a position of the specific point recognized at the prescribed period. The drive control part is configured to control the drive unit based on the variation in the rotational speed. The pressing control part is configured to control the pressing mechanism based on the meandering state.

### INCORPORATION BY REFERENCE

This application is based on and claims the benefit of priority from Japanese patent application No. 2020-102825 filed on Jun. 15, 2020, which is incorporated by reference in its entirety.

### BACKGROUND

The present disclosure relates to a fixing device used for an image forming apparatus such a copying machine, a printer, a facsimile and a multifunctional peripheral and an image forming apparatus including the fixing device.

In an image forming apparatus such as a copying machine, a fixing device is widely used. The fixing device melts and fixes an unfixed toner image on a sheet, as a recording medium, by heating and pressing. As such a fixing device, for example, a configuration is known, in which an endless fixing belt to be heated (a heated rotational body) and a pressing roller (a pressing rotational body) come pressure contact with each other to form a fixing nip area, and the unfixed toner image is fixed on the sheet at the fixing nip area.

By the way, the fixing belt expands due to the heating, and the circumference of the fixing belt is varied depending on a heating temperature. In a case where the rotational speed of the pressing roller is constant, when the circumference of the fixing belt is varied, the rotational speed of the fixing belt is varied. Further, in the case where the rotational speed of the pressing roller is constant, the pressing roller expands due to the heating of the fixing belt and the circumference of the pressing roller is varied, the rotational speed (the circumferential speed) of the pressing roller is varied. Thus, a conveyance speed of the sheet passed through the fixing nip area between the fixing belt and the pressing roller is varied. Therefore, it is required to correct the rotational speed of the fixing belt so as to keep the conveyance speed of the sheet passed through the fixing nip area constant even if the circumference of the fixing belt is varied due to the heating and the rotational speed of the pressing roller is varied.

Further, the fixing belt may be meandered in an axial direction (a width direction of the fixing belt) with the rotating. The fixing belt has ribs (belt shifting preventing members) for restricting the meandering of the fixing belt at the end portions of the fixing belt in the width direction. However, when the meandering of the fixing belt is repeated and the ribs repeatedly come into contact with a guide for supporting the fixing belt from the inside, the ribs, that is the fixing belt may be damaged. Thus, it is required to correct the meandering of the fixing belt.

A technique for correcting both the rotational speed of the fixing belt and the meandering of the fixing belt is not proposed yet.

### SUMMARY

In accordance with an aspect of the present disclosure, a fixing device includes a heated rotational body, a heating unit, a pressing rotational body, a pressing mechanism, a drive unit, a position recognition part, a rotational state determination part, a drive control part, and a pressing control part. The heated rotational body has a pattern for position recognition on a surface. The heating unit heats the heated rotational body. The pressuring rotational body comes into pressure contact with the heated rotational body. A fixing nip area where an unfixed toner image on a recording medium is melted and fixed is formed between the pressing rotational body and the heated rotational body. The pressing mechanism is configured to press the pressing rotational body on the heated rotational body. The drive unit is configured to drive the pressing rotational body to be rotated. The position recognition part is configured to recognize a specific point contained in the pattern at a prescribed period. The rotational state determination part is configured to determine a variation in a rotational speed of the heated rotational body and a meandering state of the heated rotational body based on a position of the specific point recognized at the prescribed period. The drive control part is configured to control the drive unit based on the variation in the rotational speed of the heated rotational body. The pressing control part is configured to control the pressing mechanism based on the meandering state of the heated rotational body such that pressing forces applied to end portions in a rotational axial direction of the pressing rotational body are relatively changed.

In accordance with an aspect of the present disclosure, an image forming apparatus includes the fixing device and an image forming section which forms the unfixed toner image on the recording medium which conveyed to the fixing device.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a sectional view schematically showing an inner structure of an image forming apparatus including a fixing device according to one embodiment of the present disclosure.

FIG. 2 is a sectional view schematically showing a structure of the fixing device.

FIG. 3 is a sectional view schematically showing a fixing belt of the fixing device.

FIG. 4 is a side view showing the fixing belt.

FIG. 5 is a plan view showing the fixing belt and a pressing roller coming into pressure contact with the fixing belt.

FIG. 6 is a block diagram schematically showing a control system of the fixing device.

FIG. 7 is a flow chart showing an operation for controlling a drive part and a pressing mechanism based on a rotational state of the fixing belt.

FIG. 8 is a view explaining an example of a pattern image on the surface of the fixing belt, photographed at an optional timing.

FIG. 9 is a view schematically showing various pattern images consecutively obtained at a prescribed period.

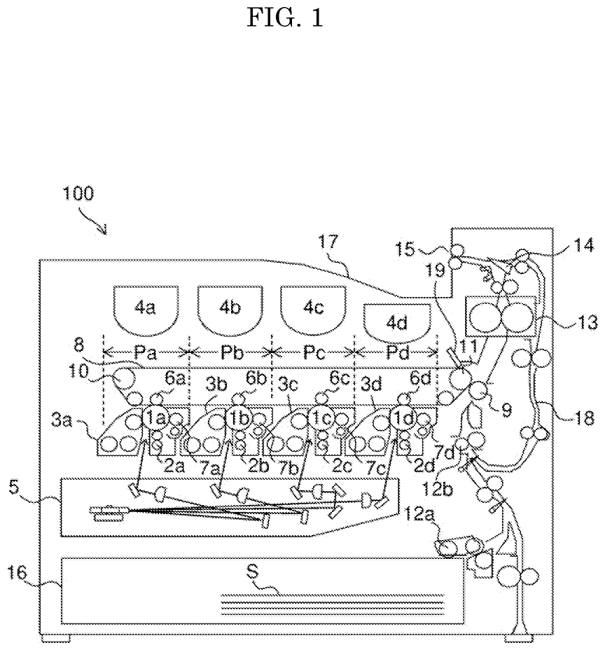

### DETAILED DESCRIPTION

[Structure of Image Forming Apparatus] Hereinafter, with reference to the attached drawings, one embodiment in the present disclosure will be described. FIG. 1 is a sectional view schematically showing an inner structure of an image forming apparatus 100 including a fixing device 13 according to the embodiment of the present disclosure. In a main body of the image forming apparatus 100 (for example, a color printer in the embodiment), four image forming sections Pa, Pb, Pc and Pd are disposed in order along one direction (in a direction from the left side to the right side in FIG. 1). These image forming sections Pa to Pd are provided corresponding to images of different four colors (cyan, magenta, yellow and black), and form cyan, magenta, yellow and black images in order by charging processing, exposure processing, development processing and transferring processing.

These image forming sections Pa to Pd include photosensitive drums (an image carrier) 1a, 1b, 1c and 1d on which a visible image (a toner image) of each color is carried. Further, an intermediate transferring belt 8 traveling in the counterclockwise direction in FIG. 1 is provided adjacent to the image forming sections Pa to Pd. The toner images formed on the photosensitive drums 1a to 1d are primarily transferred in order and overlapped on the intermediate transferring belt 8 traveling while coming into contact with the photosensitive drums 1a to 1d. After that, the toner images primarily transferred on the intermediate transferring belt 8 are secondarily transferred on a sheet S, as an example of a recording medium, by a second transferring roller 9. The sheet S is discharged from the main body of the image forming apparatus 100 after the toner image is fixed in the fixing device 13. The image forming processing for the photosensitive drums 1a to 1d is carried out as the photosensitive drums 1a to 1d are rotated in the clockwise direction in FIG. 1 by a main motor (not shown).

The sheet S on which the toner image is secondarily transferred is stored in a sheet feeding cassette 16 disposed in the lower portion of the main body of the image forming apparatus 100. The sheet S in the sheet feeding cassette 16 is conveyed to a nip area between the second transferring roller 9 and a drive roller 11 for driving the intermediate transferring belt 8 by a sheet feeding roller 12a and a resist rollers pair 12b. As the intermediate transferring belt 8, an endless (seamless) belt made of dielectric resin sheet is used conventionally. On a downstream side of the second transferring roller 9, a blade shaped belt cleaner 19 is disposed so as to remove the toner remaining on the surface of the intermediate transferring belt 8.

Next, the image forming sections Pa to Pd will be described. Around and below the rotatable photosensitive drums 1a to 1d, charging devices 2a, 2b, 2c and 2d, an exposure device 5, development devices 3a, 3b, 3c and 3d, and cleaning devices 7a, 7b, 7c and 7d are provided. The charging devices 2a to 2d charge the photosensitive drums 1a to 1d. The exposure device 5 exposes the photosensitive drums 1a to 1d based on an image data. The development devices 3a to 3d form the toner images on the photosensitive drums 1a to 1d. The cleaning devices 7a to 7d remove the developer (the toner) and the other remaining on the photosensitive drums 1a to 1d.

When the image data is input from a host device such as a personal computer, first, the surfaces of the photosensitive drums 1a and 1d are uniformly charged by the charging devices 2a to 2d. Secondary, the surfaces of the photosensitive drums 1a to 1d are exposed with light emitted from the exposure device 5 based on the image data. Then, electrostatic latent images based on the image data are formed on the photosensitive drums 1a to 1d. The development devices 3a to 3d are filled with a predetermined amount of the developer (for example, a two-component developer) containing the cyan, magenta, yellow and black toner. The toner in the developer is supplied to the photosensitive drums 1a to 1d by the development devices 3a to 3d and electrostatically attracted to the photosensitive drums 1a to 1d. Thus, the toner images corresponding to the electrostatic latent images formed by the exposing of the exposure device 5 are formed. When a rate of the toner in the two-component developer filled in each of the development devices 3a to 3d becomes less than a specified rate owing to the above toner image formation, the toner is replenished to the corresponding development device of the development devices 3a to 3d from the corresponding toner container of the toner containers 4a to 4d.

When the primary transferring rollers 6a to 6d apply an electric field at a predetermined transferring voltage between the primary transferring rollers 6a to 6d and the photosensitive drums 1a to 1d, the cyan, magenta, yellow and black toner images on the photosensitive drums 1a to 1d are primarily transferred on the intermediate transfer belt 8. These four color images are formed with a predetermined positional relationship predetermined for forming a predetermined full-color image. Thereafter, in preparation to form a new electrostatic latent image subsequently, the toner and the others remaining on the surfaces of the photosensitive drums 1a to 1d after the primary transferring are removed by the cleaning devices 7a to 7d.

The intermediate transferring belt 8 is wound between an upstream driven roller 10 and the downstream drive roller 11. When the intermediate transferring belt 8 starts to travel in the counterclockwise direction as the drive roller 11 is rotated by a belt drive motor (not shown), the sheet S is conveyed from the resist rollers pair 12b to the nip area (a secondary transferring nip area) between the drive roller 11 and the secondary transferring roller 9 at a predetermined timing. In the nip area, the full-color image on the intermediate transferring belt 8 is secondarily transferred on the sheet S. The sheet S on which the toner image is secondarily transferred is conveyed to the fixing device 13.

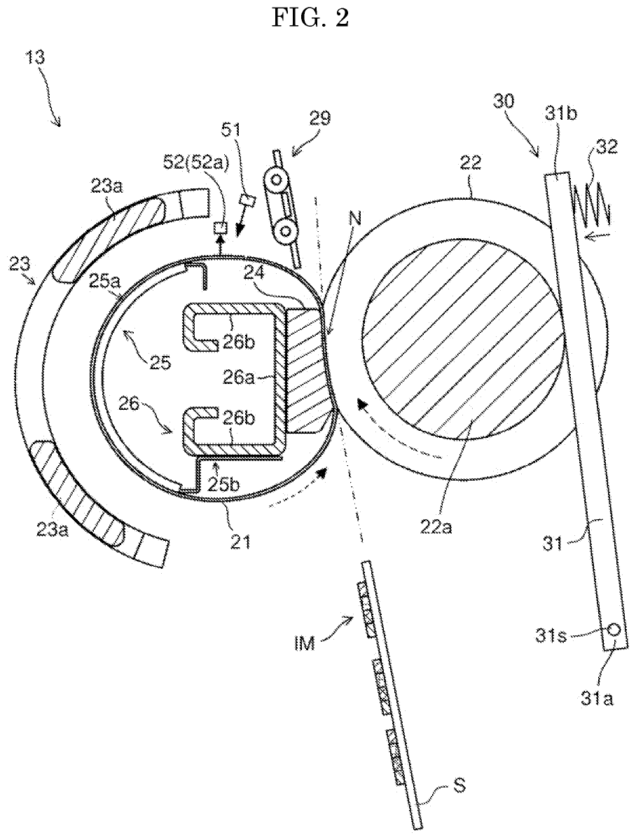

The sheet S conveyed to the fixing device 13 is heated and pressed by a fixing belt 21 and a pressing roller 22 (see FIG. 2). Thus, the toner image is fixed to the surface of the sheet S, and the predetermined full-color image is formed. The conveyance path of the sheet S on which the full-color image is formed is branched at a branch portion 14 branched in a plurality of directions, and is discharged to a discharge tray 17 by a discharge roller pair 15 as it is (alternatively, after the sheet is fed to a double-sided conveying path 18 and the images are formed on both sides).

[2. Structure of Fixing Device] FIG. 2 is a sectional view schematically showing a structure of the fixing device 13 described above. The upper side in FIG. 2 shows a downstream side in a sheet passing direction (a conveyance direction) for the fixing device 13, and the lower side in FIG. 2 shows an upstream side in the sheet passing direction for the fixing device 13. The fixing device 13 includes the fixing belt 21 (a heated rotational body), the pressing roller 22 (a pressing rotational body), a heating unit 23, a nip formation member 24, a belt guide 25, a frame member 26 and a pressing mechanism 30.

The fixing belt 21 is supported by a housing (not shown) of the fixing device 13 in a rotatable manner around a horizontal axis. The fixing belt 21 is formed into an endless cylindrical shape having an outer diameter of 20 mm to 50 mm, for example. The fixing belt 21 has an axial length (a length in a width direction of the sheet S) almost equal to an axial length of the pressing roller 22. The fixing belt 21 rotates in the counterclockwise direction in FIG. 2 along the conveyance direction of the sheet S, as a recording medium. The rotational direction of the fixing belt 21 is also called a circumferential direction.

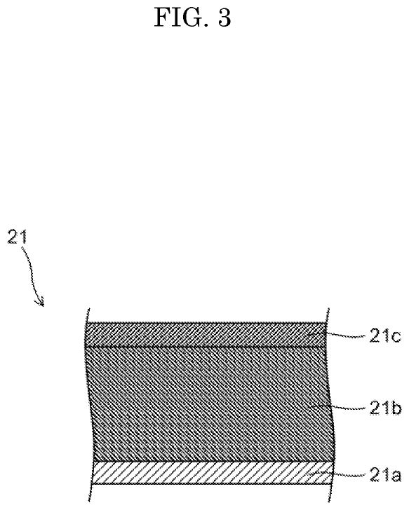

FIG. 3 is a sectional view schematically showing a structure of the fixing belt 21. The fixing belt 21 has a layered structure having a heating layer 21a as a base layer, an elastic layer 21b and a release layer 21c which are provided around the heating layer 21a in order from the inside. The heating layer 21a is made of a metal film, such as a nickel film, having a thickness of 30 μm to 50 μm, or a polyimide film mixed with metal powder, such as copper, silver and aluminum, and having a thickness of 50 μm to 100 μm, for example. The elastic layer 21b is made of silicon rubber, and has a thickness of 100 μm to 500 μm, for example. The release layer 21c is made of fluorine-based resin, such as PFA (tetrafluoroethylene-perfluoroalkyl vinyl ether copolymer), and has a thickness of 30 μm to 50 μm, for example.

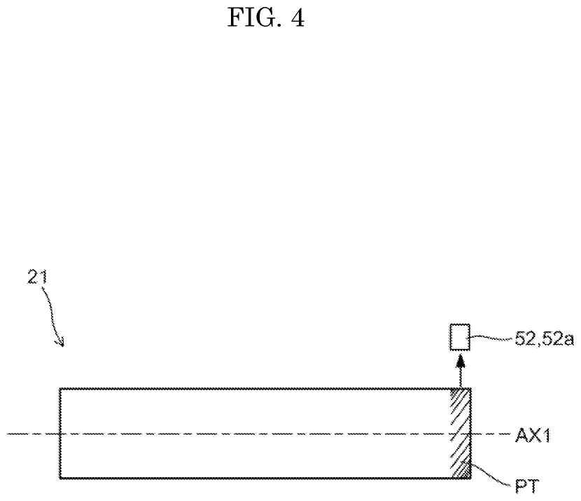

FIG. 4 is a side view showing the fixing belt 21. The fixing belt 21 has a pattern PT for position recognition on the surface. The pattern PT is provided on one end portion of the surface of the fixing belt 21 in an axial direction (the belt width direction) of an axis AX1 which is a rotational axis. The pattern PT is photographed by an image sensor 52a which is an example of a position recognition part 52 described later. Thus, the image of the pattern PT is obtained. The obtained image of the pattern PT is used when in a rotational state determination part 60b, described later, determines a variation in a rotational speed of the fixing belt 21 and a meandering state of the fixing belt 21.

The pattern PT is formed such that linear protrusions or linear grooves extending obliquely with respect to the belt width direction are arranged side by side in the circumferential direction at equal intervals. The pattern PT is not limited to the pattern in which the protrusions or the grooves are regularly arranged at equal intervals in the circumferential direction, but may be a pattern in which the protrusions or the grooves are arranged randomly in the circumferential direction. Further, the pattern PT is not limited to the linear protrusions or the linear grooves, but may be a pattern formed by making the surface roughness by sandblast processing, for example.

As shown in FIG. 2, the pressing roller 22 is supported by the housing of the fixing device 13 in a rotatable manner around a horizontal rotational axis. The pressing roller 22 is formed into a column shape, and has an axial length (a length in the width direction of the sheet S) almost equal to the axial length of the fixing belt 21.

The pressing roller 22 has a layered structure having a core metal 22a, an elastic layer and a release layer provided around the core metal 22a in order. The core metal 22a is made of metal, such as aluminum, and has a diameter of 20 mm, for example. The core metal 22a has an axial length longer than that of the elastic layer and the release layer. The elastic layer is made of silicon rubber, and has a thickness of 8 mm, for example. The release layer is made of fluorine-based resin, and has a thickness of 10 μm to 50 μm, for example.

A predetermined pressure is applied to the pressing roller 22 toward the fixing belt 21 by the pressing mechanism 30. The outer circumferential face of the pressing roller 22 is pressed on the nip formation member 24 across the fixing belt 21, and comes into pressure contact with the outer circumferential face of the fixing belt 21. Then, between the outer circumferential faces, the fixing nip area N is formed. That is, the pressing roller 22 comes into pressure contact with the fixing belt 21, and the fixing nip area N where an unfixed toner image IM on the sheet S is melt and fixed is formed between the pressing roller 22 and the fixing belt 21.

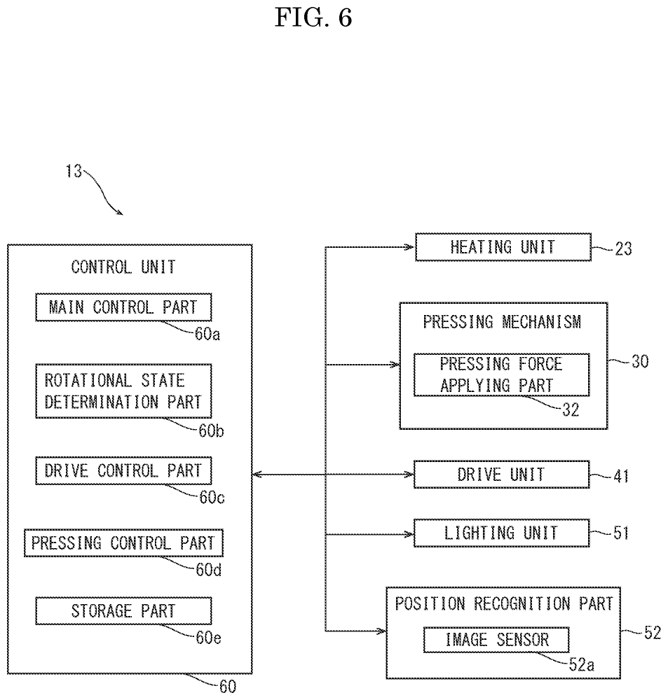

The pressing roller 22 rotates in the clockwise direction by a drive unit 41 (see FIG. 6) described later. The pressing roller 22 comes into contact with the outer circumferential face of the fixing belt 21, and applies a rotational drive force in the counterclockwise direction to the fixing belt 21. This makes it possible to drive the fixing belt 21 to be rotated.

The heating unit 23 is disposed on an area opposite to an area where the pressing roller 22 is disposed, with respect to the fixing belt 21, and faces the outer circumferential face of the fixing belt 21 via a predetermined gap. The heating unit 23 extends along the axial direction of the fixing belt 21 slightly longer than the fixing belt 21. The heating unit 23 applies heat to the heating layer 21a of the fixing belt 21 in an introduction heating manner, and heats the fixing belt 21.

The heating unit 23 includes an excitation coil 23a, a holder, a core (which are not shown) and the others. The excitation coil 23a and the core are held by the holder at a predetermined position. The excitation coil 23a is made of a litz wire made of conductive wires bundle, and is wound so as to extend along the axial direction of the fixing belt 21. The excitation coil 23a is formed into an arc shape around the outer circumferential face of the fixing belt 21 along the circumferential direction of the fixing belt 21.

The nip formation member 24 is disposed inside the fixing belt 21 so as to face the pressing roller 22 across the fixing belt 21. The nip formation member 24 comes into contact with the inner circumferential face of the fixing belt 21, and forms the fixing nip area N between the fixing belt 21 and the pressing roller 22.

The nip formation member 24 has an approximately parallelepiped shape extending in the axial direction of the fixing belt 21 and having a length almost equal to the length of the fixing belt 21. The nip formation member 24 has a base material made of metal such as aluminum, or heat resistant resin such as liquid crystal polymer, for example. The nip formation member 24 may have an elastic layer made of elastomer or silicon rubber, for example, on the surface facing the fixing belt 21. The nip formation member 24 has a sheet member (a release layer) made of fluorine-based resin such as PFA on the face facing the fixing belt 21. The nip formation member 24 has a sheet member (a release layer) made of fluorine-based resin, such as PFA, for example, on the surface facing the fixing belt 21. The sheet member comes into contact with the inner circumferential face of the fixing belt 21 at the fixing nip area N, and extends in the upstream area and in the downstream area in the rotational direction of the fixing belt 21 from the fixing nip area N, with which the fixing belt 21 does not come into contact.

The belt guide 25 is disposed in the inside of the fixing belt 21 so as to face the heating unit 23 across the fixing belt 21. The belt guide 25 comes into contact with the inner circumferential face of the fixing belt 21 other than the fixing nip area N, and supports the fixing belt 21 from the inside. The belt guide 25 is formed by a metal plate having a length shorter than the fixing belt 21 in the axial direction of the fixing belt 21. The fixing belt 21 has ribs (not shown) in both the axial end portions. If a displacement amount (a meandering amount) of the fixing belt 21 in the axial direction exceeds a prescribed value, the ribs come into contact with the belt guide 25 to restrict the meandering of the fixing belt 21. The belt guide 25 is made of magnetic elastic metal, such as SUS430, and has a thickness of 0.1 mm to 0.5 mm, for example. The belt guide 25 has a contact part 25a and a connection part 25b.

The contact part 25a is disposed on an opposite side to the fixing nip area N with respect to a radial center of the fixing belt 21. The contact part 25a is curved in an arc shape along the inner circumferential face of the fixing belt 21. The contact part 25a comes into contact with the inner circumferential face of the fixing belt 21 with almost its outer circumferential face. The contact part 25a faces the excitation coil 23a across the fixing belt 21.

The connection part 25b is disposed on the downstream side of the contact part 25a in the rotational direction of the fixing belt 21. The connection part 25b is coupled to a circumferential end portion of the contact part 25a. The connection part 25b bents from the circumferential end portion of the contact part 25a inward radially, and then bents toward the fixing nip area N adjacently the frame member 26. The connection part 25b does not come into contact with the fixing belt 21.

The frame member 26 is disposed in almost the radial center portion of the fixing belt 21 between the contact part 25a of the belt guide 25 and the nip formation member 24. The frame member 26 extends slightly longer than the fixing belt 21 along the axial direction of the fixing belt 21.

The frame member 26 holds the nip formation member 24 and the belt guide 25. The nip formation member 24 is fixed to a nip side wall portion 26a of the frame member 26 facing the fixing nip area N. The connection part 25b of the belt guide 25 is fixed to a side wall portion 26b of the frame member 26 on the upstream side of the rotational direction of the fixing belt 21.

On the downstream side (the upper side in FIG. 2) of the fixing nip area N in the sheet conveyance direction, a separator 29 is disposed. The separator 29 separates the sheet S passed through the fixing nip area N from the outer circumferential face of the fixing belt 21.

The pressing mechanism 30 is a mechanism for pressing the pressing roller 22 on the fixing belt 21. The pressing mechanism 30 includes a rod-shaped pressing lever 31 and a pressing force applying part 32. The pressing levers 31 are provided in the axial end portions of a supporting shaft 31s. The supporting shaft 31s extends in parallel with the rotational axis of the pressing roller 22 (the central axis of the core metal 22a), and is disposed separated away from the pressing roller 22. One end portion 31a of the pressing lever 31 (the lower end portion in FIG. 2) is connected to the supporting shaft 31s in a sliding and turnable manner. Then, the pressing lever 31 is turnable around the supporting shaft 31s. The pressing lever 31 comes into contact with the core metal 22a between the one end portion 31a and the other end portion 31b (the upper end portion in FIG. 2).

The pressing force applying part 32 applies a pressing force to the pressing lever 31. That is, the pressing force applying part 32 presses the other end portion 31b of the pressing lever 31 so as to press the pressing lever 31 toward the core metal 22a. The pressing force applying part 32 includes a spring and a pushing part which pushes the spring toward the pressing lever 31. A pushing amount of the spring is adjustable so that it becomes possible to adjust the pressing force (a load) of the pressing lever 31 by the pressing force applying part 32. The pressing lever 31 is turned around the supporting shaft 31s in the counterclockwise direction in FIG. 2 by the pressing force applied by the pressing force applying part 32. This makes it possible to press the pressing roller 22 toward the fixing belt 21.

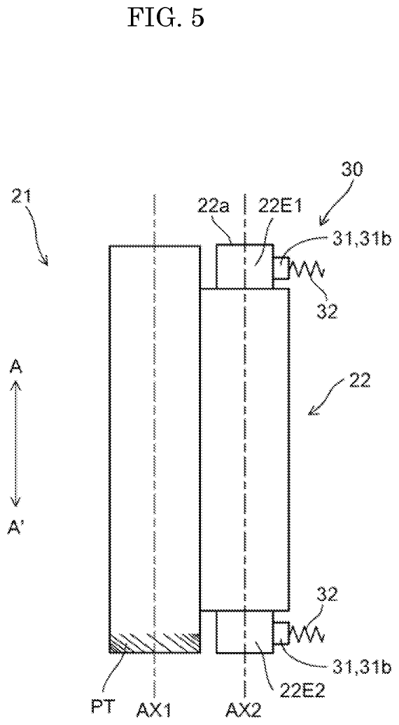

FIG. 5 is a plan view showing the fixing belt 21 and the pressing roller 22. In a direction (an axial direction) of a rotational axis AX2 of the pressing roller 22, one end portion of the core metal 22a of the pressing roller 22 is defined as 22E1, and the other end portion is defined as 22E2. The pressing lever 31 and the pressing force applying part 32 are provided for each of the end portions 22E1 and 22E2 of the pressing roller 22. This makes it possible to set or adjust the pressing force for each pressing lever 31 by the corresponding pressing force applying part 32 individually and to set or adjust the pressing force applied to each of the end portions 22E1 and 22E2 of the pressing roller 22 individually.

Further, the fixing device 13 includes a configuration for detecting a rotational frequency of the fixing belt 21. For example, a reflection member (for example, a member made of aluminum foil) is provided in a part of the fixing belt 21 in the circumferential direction, light (for example, infrared light) is emitted toward the fixing belt 21 from a light emitting part, and the light reflected by the reflection member is received by a light reception part. Then, a rotational frequency of the fixing belt 21 is obtained by a light reception frequency of the light reception part. Conventionally, although a drive control part 60c (see FIG. 6) of a control unit 60 described later controls the drive unit 41 so as to keep the rotational frequency constant, if a rotational speed of the fixing belt 21 is varied depending on a variation of the circumference of the fixing belt 21, a control described later is performed in order to correct the rotational speed of the fixing belt 21.

[3. Control System of Fixing Device] FIG. 6 is a block diagram schematically showing a structure of a control system of the fixing device 13. The fixing device 13 includes the drive unit 41, a lighting unit 51, the position recognition part 52 and the control unit 60, in addition to the above-described configuration. The drive unit 41 includes a motor, a gear train and the others, and drives the pressing roller 22 to rotate it. The pressing roller 22 is rotated with a drive force applied from the motor.

The position recognition part 52 recognizes the pattern PT provided on the surface of the fixing belt 21 at a prescribed period, and recognizes a position of a specific point contained in the pattern PT at the prescribed period. The position recognition part 52 includes the image sensor 52a which photographs the pattern PT, obtains an image of the pattern PT and recognizes the specific point of the pattern PT from the obtained image.

The above prescribed period may be a period shorter than the above rotational period of the fixing belt 21, for example. In this case, during one rotation of the fixing belt 21, the position recognition of the specific point of the pattern PT is performed for several times.

The position recognition part 52 (the image sensor 52a) is disposed above the fixing belt 21 as shown in FIG. 2, but it is sufficient as long as it is disposed so as to photograph the pattern PT of the fixing belt 21, and the position of the position recognition part 52 is not limited to the position above the fixing belt 21.

The lighting unit 51 lights the fixing belt 21, especially, the pattern PT provided on the surface of the fixing belt 21. The lighting unit 51 includes a LED (a light emitting diode) emitting visible light (for example, white light), and is disposed near the position recognition part 52. By lighting the pattern PT by the lighting unit 51, the image sensor 52a of the position recognition part 52 allows to photograph the bright pattern PT, and to obtain an image of the clear pattern PT. This makes it possible for the image sensor 52a to recognize a position of the specific point of the pattern PT from the obtained image with high accuracy.

It is possible not to provide the lighting unit 51, but, because the inside of the main body of the image forming apparatus 100 is usually dark, it is preferable to provide the lighting unit 51 such that the image sensor 52a can photograph the bright pattern PT.

The control unit 60 shown in FIG. 6 includes, for example, a central processing unit (CPU) and a memory. Specifically, the control unit 60 includes a main control part 60a, the rotational state determination part 60b, the drive control part 60c, a pressing control part 60d and a storage part 60e. The main control part 60a, the rotational state determination part 60b, the drive control part 60c and the pressing control part 60d may be formed by the same CPU, or separate CPUs.

The main control part 60a controls the operations of the fixing device 13 and other parts of the image forming apparatus 100. The main control part 60a controls the heating unit 23 based on a temperature of the fixing belt 21 detected by an infrared light sensor (not shown) provided in the inside of the fixing device 13. Thus, it becomes possible to control a temperature of the fixing belt 21 within a predetermined temperature range suitable for fixing.

The rotational state determination part 60b determines a variation in a rotational speed of the fixing belt 21 and a meandering state of the fixing belt 21 as a rotational state based on a position of the specific point recognized for every prescribed period. A specifically determination way of the rotational state will be described later in detail.

The drive control part 60c controls the drive unit 41 based on a variation in the rotational speed of the fixing belt 21 determined by the rotational state determination part 60b to control the rotation of the pressing roller 22. Thus, the rotation of the fixing belt 21 rotating by being driven by the rotation of the pressing roller 22 can be indirectly controlled.

The pressing control part 60d controls the pressing mechanism 30 based on a meandering state of the fixing belt 21 determined by the rotational state determination part 60b to relatively change the pressing forces applied to both the end portions 22E1 and 22E2 (see FIG. 5) of the pressing roller 22 in the direction of the rotational axis AX2 of the pressing roller 22. For example, in FIG. 5, when the pressing force applied to the end portion 22E1 of the pressing roller 22 is made higher than that to the end portion 22E2, the fixing belt 21 brought into pressure contact with the pressing roller 22 shifts toward a side where the pressing force is higher (in the direction A in FIG. 5) in the direction of the rotational axis AX1. On the other hand, when the pressing force applied to the end portion 22E2 of the pressing roller 22 is made higher than that to the end portion 22E1, the fixing belt 21 shifts toward a side where the pressing force is higher (the direction A′ in FIG. 5) in the direction of the rotational axis AX1. Therefore, the pressing mechanism 30 relatively changes the pressing forces applied to the end portions 22E1 and 22E2 of the pressing roller 22, so that it becomes possible to shift the fixing belt 21 in the direction of the rotational axis AX1 and to correct a meandering of the fixing belt 21.

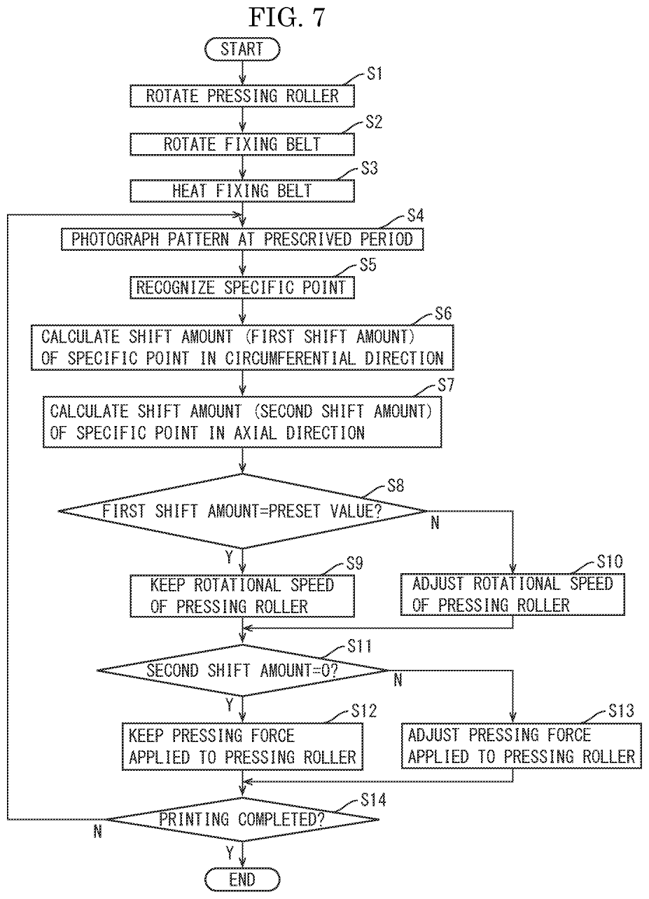

The storage part 60e is a memory for storing an operation program of the control unit 60 and various kinds of information, and includes a ROM (a Read Only Memory), a RAM (a Random Access Memory), a nonvolatile memory, and the like. The information stored in the storage part 60e includes a data of the image obtained by the image sensor 52a.

[4. Control of Drive Part and Pressing Mechanism Based on Rotational State of Fixing Belt] Next, a control of the drive unit 41 and the pressing mechanism 30 based on a rotational state of the fixing belt 21 in the present embodiment will be described. FIG. 7 is a flow chart showing a control of the drive unit 41 and the pressing mechanism 30 based on the rotational state of the fixing belt 21.

First, the drive control part 60c (see FIG. 6) of the control unit 60 controls the drive unit 41 to rotate the pressing roller 22 in the clockwise direction in FIG. 2 (S1). Thus, the fixing belt 21 coming into pressure contact with the pressing roller 22 is rotated in the counterclockwise direction in FIG. 2 (S2). A timing at which the drive control part 60c starts the rotation of the pressing roller 22 is appropriately controlled at a timing determined in accordance with the image forming operations in the image forming sections Pa to Pd.

Next, the main control part 60a controls the heating unit 23 to heat the heating layer 21a of the fixing belt 21 and to heat the fixing belt 21 to a predetermined temperature (for example, 160° C.) (S3). The fixing belt 21 may be heated in parallel with S2 or before the pressing roller 22 is rotated in S1.

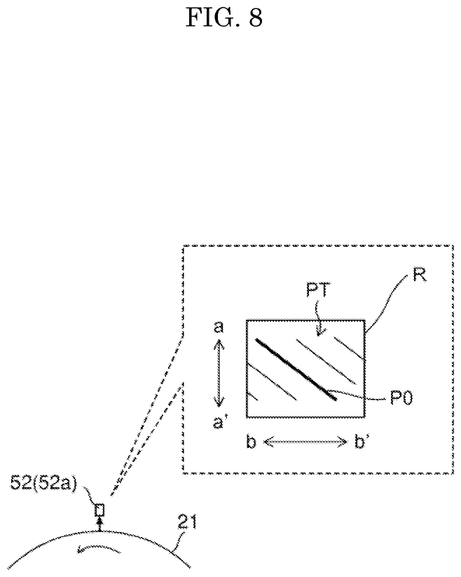

Next, the image sensor 52a of the position recognition part 52 photographs the pattern PT provided on the surface of the fixing belt 21 at the prescribed period L (sec) (S4). Thus, a photographed image of the pattern PT is obtained for each prescribed period L. FIG. 8 shows an example of the image R of the pattern PT photographed at an arbitrary timing. In FIG. 8, the vertical direction (the aa′ direction) of the image R corresponds to the direction of the rotational axis AX1 of the fixing belt 21 (the AA′ direction in FIG. 5), and the horizontal direction (the bb′ direction) corresponds to the circumferential direction of the fixing belt 21.

Subsequently, the image sensor 52a recognizes the position of the specific point P0 contained in the pattern PT from the image R of the obtained pattern PT (S5). In particular, since the image sensor 52a photographs the pattern PT at the prescribed period L, the position of the specific point P0 contained in the pattern PT is recognized at the prescribed period L (every prescribed period L). In FIG. 8, the specific point P0 contained in the pattern PT is defined as a specific linear projection here, and is indicated by a thick line in order to clearly distinguish it from other portions. In order for the image sensor 52a to easily recognize the specific point P0, the pattern PT may be formed on the surface of the fixing belt 21 by making a color, shape, and the like of the specific point P0 different from those of other portions.

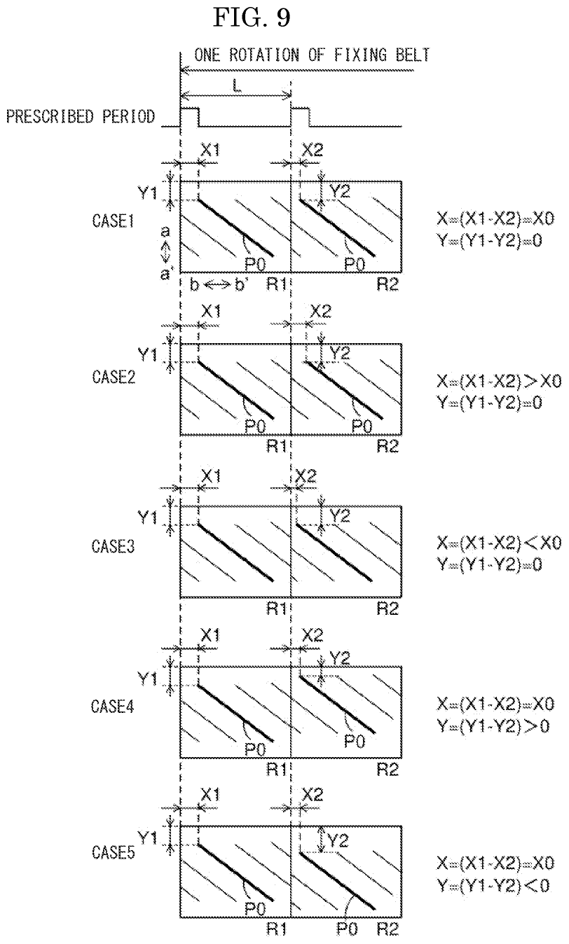

Next, the rotational state determination part 60b calculates a shift amount of the specific point P0 in the circumferential direction of the fixing belt 21 as a first shift amount X (mm) based on a plurality of the positions of the specific point P0 recognized for every prescribed period L (S6). FIG. 9 schematically shows variations of the images R1 and R2 of the pattern PT continuously obtained at the prescribed period L. In a direction (the bb′ direction) corresponding to the circumferential direction of the images R1 and R2, assuming that a distance between the leading end of the image R1 obtained earlier and the leading end of the specific point P0 is X1 (mm) and a distance between the leading end of the image R2 obtained later and the leading end of the specific point P0 is X2 (mm), the rotational state determination part 60b can calculate the first shift amount X of the specific point P0 with the rotation of the fixing belt 21 by calculating X1-X2.

Subsequently, the rotational state determination part 60b calculates a shift amount of the specific point P0 in the direction of the rotational axis AX1 of the fixing belt 21 as a second shift amount Y (mm) based on a plurality of the positions of the specific point P0 recognized for every prescribed period L (S7). In a direction (the aa′ direction) corresponding to the axial direction of the images R1 and R2 in FIG. 9, assuming that a distance between the leading end of the image R1 obtained earlier and the leading end of the specific point P0 is Y1 (mm), and a distance between the leading end of the image R2 obtained later and the leading end of the specific point P0 is Y2 (mm), the rotational state determination part 60b can calculate the second movement amount Y of the specific point P0 by calculating Y1-Y2.

Next, the rotational state determination part 60b determines whether the first shift amount X calculated in S6 is equal to a preset value X0 (mm) previously set as a shift amount at the prescribed period L (S8). For example, as shown in cases 1, 4, and 5 in FIG. 9, when the first shift amount X is equal to the set value X0, the rotational state determination part 60b determines that the rotational speed of the fixing belt 21 is as specified and is not changed. In this case, the drive control part 60c controls the drive unit 41 so as to keep the rotational speed of the pressing roller 22 constant (S9). Thus, a conveyance speed of the sheet S passing through the fixing nip area N is kept within a predetermined range.

On the other hand, as shown in cases 2 and 3 in FIG. 9, when the first shift amount X is not equal to the preset value X0, the rotational state determination part 60b determines that the rotational speed of the fixing belt 21 is changed. In particular, as in the case 2, when the first shift amount X is larger than the preset value X0, the rotational state determination part 60b determines that the rotational speed of the fixing belt 21 is decreased. As in the case 3, when the first shift amount X is smaller than the preset value X0, the rotational state determination part 60b determines that the rotational speed of the fixing belt 21 is increased. Then, the drive control part 60c controls the drive unit 41 based on the determination (a change in the rotational speed of the fixing belt 21) of the rotational state determination part 60b to adjust the rotational speed of the pressing roller 22 (S10). Specifically, in the case 2, the drive control part 60c controls the drive unit 41 so as to increase the rotational speed of the pressing roller 22. On the other hand, in the case 3, the drive control part 60c controls the drive unit 41 so as to decrease the rotational speed of the pressing roller 22. Thus, a conveyance speed of the sheet S passing through the fixing nip area N can be kept within a predetermined range.

Next, the rotational state determination part 60b determines whether the second shift amount Y calculated in S7 is 0 (mm) (S11). For example, as in the case 1 to 3 in FIG. 9, when the second shift amount Y is 0 (mm), the rotational state determination part 60b determines that a meandering (a displacement in the direction of the rotational axis AX1) of the fixing belt 21 does not occur. In this case, the pressing control part 60d controls the pressing mechanism 30 so as to keep the pressing forces applied to the end portions 22E1 and 22E2 of the pressing roller 22 in the direction of the rotational axis AX2 constant (S12).

On the other hand, as shown in the cases 4 and 5 in FIG. 9, when the second shift amount Y is not 0 (mm), the rotational state determination part 60b determines that a meandering of the fixing belt 21 occurs. In particular, as in the case 4, when the second shift amount Y is larger than 0 (mm), the rotational state determination part 60b determines that the fixing belt 21 meanders in one side in the axial direction (the direction A in FIG. 5). As in the case 5, when the second shift amount Y is smaller than 0 (mm), the rotational state determination part 60b determines that the fixing belt 21 meanders in the other side in the axial direction (the A′ direction in FIG. 5). Then, the pressing control part 60d controls the pressing mechanism 30 based on the determination of the rotational state determination part 60b and to adjust the pressing forces applied to the end portions 22E1 and 22E2 of the pressing roller 22 (S13).

More specifically, in the case 4, the pressing control part 60d controls the pressing mechanism 30 so as to increase the pressing force applied to the end portion 22E2 of the pressing roller 22, or to decrease the pressing force applied to the end portion 22E1, or to perform them at the same time. On the other hand, in the case 5, the pressing control part 60d controls the pressing mechanism 30 so as to increase the pressing force applied to the end portion 22E1 of the pressing roller, or to decrease the pressing force applied to the end portion 22E2, or to perform them at the same time. By adjusting the pressing force applied to at least one of the end portions 22E1 and 22E2 in the above manner, the fixing belt 21 is displaced in the direction of the rotational axis AX1 as described above, thereby correcting the meandering of the fixing belt 21.

Thereafter, the processing from S4 is repeated until the printing is completed (S14), and the series of processing is completed when the printing is completed.

As described above, the drive control part 60c controls the drive unit 41 based on a variation in a rotational speed of the fixing belt 21 (S8, S10). Thus, even if a circumference of the fixing belt 21 is varied depending on a variation in a heating temperature of the heating unit 23 or a circumference of the pressing roller 22 is varied depending on an expansion of the pressing roller 22 due to the heat of the fixing belt 21 and a rotational speed of the pressing roller 22 is varied, the drive unit 41 adjusts the rotational speed of the pressing roller 22 such that a rotational speed of the fixing belt 21 coming into pressure contact with the pressing roller 22 is corrected so as to keep a conveyance speed of the sheet S passed through the fixing nip area N constant. Further, the pressing control part 60d controls the pressing mechanism 30 based on a meandering state of the fixing belt 21 to relatively vary the pressing forces applied to the end portions 22E1 and 22E2 of the pressing roller 22 in the direction of the rotational axis AX2 (S11, S13). Thus, even if the fixing belt 21 is meandered, the fixing belt 21 is shifted to a direction opposite to a direction in which the fixing belt 21 is meandered, so that it becomes possible to correct the meandering of the fixing belt 21.

That is, according to the configuration of the present embodiment, it becomes possible to correct both a rotational speed of the fixing belt 21 and a meandering of the fixing belt 21. Particularly, if an amount of the meandering of the fixing belt 21 is large, the ribs (not shown) provided in the axial end portion of the fixing belt 21 comes into contact with the belt guide 25 and the fixing belt 21 may be damaged. However, the above correction of the meandering makes it possible to inhibit the rib and the fixing belt 21 from being damaged.

Further, the rotational state determination part 60b calculates a shift amount of the specific point PO in the circumferential direction (the bb′ direction) of the fixing belt 21 as a first shift amount based on a plurality of the positions of the specific point PO recognized for every prescribed period L, and determines a variation in a rotational speed of the fixing belt 21 based on the calculated shift amount X and the preset set value X0 previously set as a shift amount at the prescribed period L (S8). A difference between the first shift amount X and the set value X0 directly indicates whether the rotational speed of the fixing belt 21 is varied and the variation amount of the fixing belt 21. Thus, it becomes possible to determine a variation in a rotational speed of the fixing belt 21 based on the first shift amount X and the set value X0 surely.

Further, the rotational state determination part 60b calculates a shift amount of the specific point PO in the direction of the rotational axis AX1 of the fixing belt 21 as a second shift amount Y based on a plurality of the positions of the specific point PO recognized for every prescribed period L, and determines a meandering state of the fixing belt 21 based on the calculated shift amount Y (S11). The second shift amount Y directly indicate whether the fixing belt 21 is meandered and the meandering amount of the fixing belt 21. Thus, it becomes possible to determine a meandering state of the fixing belt 21 based on the second shift amount Y surely.

Further, the drive control part 60c controls the drive unit 41 based on a variation in a rotational speed of the fixing belt 21 determined by the rotational state determination part 60b and adjust the rotational speed of the pressing roller 22, so that a conveyance speed of the sheet S passing through the fixing nip area N is kept within a predetermined range (S10). Even if a circumference of the fixing belt 21 varies and its rotational speed varies, the conveyance speed of the sheet S can be kept within a predetermined range by adjusting the rotational speed of the pressing roller 22. This can achieve a satisfactory conveyance of the sheet S.

Further, the pressing control part 60d controls the pressing mechanism 30 based on a meandering state of the fixing belt 21 determined by the rotational state determination part 60b, and relatively increases the pressing force applied to the other end portion than the pressing force applied to the one end portion positioned on a side where the fixing belt 21 is meandered, of both the end portions 22E1 and 22E2 in the direction of the rotational axis AX2 of the pressing roller 22. Thus, even if the fixing belt 21 is meandered, the meandering can be surely corrected.

Further, the position recognition part 52 includes the image sensor 52a. Thus, by using the image sensor 52a as the position recognition part 52, the position of the specific point P0 included in the pattern PT can be reliably recognized (detected).

Further, in the present embodiment, the fixing belt 21 is an example of a heated rotational body heated by the heating unit 23. The fixing belt 21 is easily varied in a circumference depending on a heating temperature. Therefore, by adjusting a rotational speed of the pressing roller 22 based on a variation in a rotational speed of the fixing belt 21, an effect of the present embodiment in which a rotational speed of the fixing belt 21 is corrected is remarkably exhibited.

The image forming apparatus 100 of the present embodiment includes the fixing device 13 having the above-described structure and the image forming sections Pa to Pd in which an unfixed toner image IM is formed on the sheet S conveyed to the fixing device 13. Even if the fixing belt 21 is thermally expanded and the rotational speed is varied, the sheet S conveyed from the image forming sections Pa to Pd can be conveyed at a conveyance speed within a predetermined range by rotating of the pressing roller 22 based on a rotational speed S of the fixing belt 21 and then discharged from the fixing device 13.

The present disclosure is not limited to the configuration of the present embodiment, and various modifications can be made without departing from the spirit of the present disclosure. For example, the heating unit 23 is not limited to a configuration including the excitation coil and the core (an induction heating type), and a configuration including a halogen heater, for example, may be used.

In the present embodiment, although the vertical conveyance type fixing device 13 in which the sheet S passes through the fixing nip area from the lower side to the upper side has been described, the configuration described in the present embodiment can also be applied to a horizontal conveyance type fixing device in which the sheet S passes horizontally through the fixing nip area N.

The image forming apparatus 100 is not limited to a tandem type color printer as shown in FIG. 1, but can be applied to various image forming apparatuses equipped with a fixing device, such as a monochrome copying machine, a digital multifunctional peripheral, a facsimile, a laser printer, and the like.

The present disclosure can be used, for example, in a fixing device of an image forming apparatus such as a copying machine, a printer, a facsimile, and a multifunctional peripheral.

1. A fixing device comprising:
a heated rotational body having a pattern for position recognition on a surface;
a heating unit heating the heated rotational body;
a pressuring rotational body coming into pressure contact with the heated rotational body, a fixing nip area where an unfixed toner image on a recording medium is melted and fixed being formed between the pressing rotational body and the heated rotational body;
a pressing mechanism configured to press the pressing rotational body on the heated rotational body;
a drive unit configured to drive the pressing rotational body to be rotated;
a position recognition part configured to recognize a specific point contained in the pattern at a prescribed period;
a rotational state determination part configured to determine a variation in a rotational speed of the heated rotational body and a meandering state of the heated rotational body based on a position of the specific point recognized at the prescribed period;
a drive control part configured to control the drive unit based on the variation in the rotational speed of the heated rotational body; and
a pressing control part configured to control the pressing mechanism based on the meandering state of the heated rotational body such that pressing forces applied to end portions in a rotational axial direction of the pressing rotational body are relatively changed.

2. The fixing device according to claim 1, wherein
the rotational state determination part calculates a shift amount of the specific point in a circumferential direction of the heated rotational body as a first shift amount based on a plurality of positions of the specific point recognized for every prescribed period, and determines the variation in the rotational speed of the heated rotational body based on the calculated first shift amount and a preset value previously set as a shift amount at the prescribed period.

3. The fixing device according to claim 1, wherein
the rotational state determination part calculates a shift amount of the specific point in a rotational axial direction of the heated rotational body as a second shift amount based on a plurality of positions of the specific point recognized for every prescribed period, and determines the meandering state of the heated rotational body based on the calculated second shift amount.

4. The fixing device according to claim 1, wherein
the drive control part controls the drive unit based on the variation in the rotational speed of the heated rotational body to adjust a rotational speed of the pressing rotational body such that a conveyance speed of the recording medium passing through the fixing nip area is kept within a predetermined range.

5. The fixing device according to claim 1, wherein
the pressing control part controls the pressing mechanism based on the meandering state of the heated rotational body to relatively increase a pressing force applied to the one end portion of the pressing rotational body higher than a pressing force applied to the other end portion of the pressing rotational body, the other end portion positioned on a side where the heated rotational body is meandered.

6. The fixing device according to claim 1, wherein
the position recognition part includes an image sensor which photographs the pattern, obtains an image of the pattern, and recognizes a position of the specific point from the obtained image.

7. The fixing device according to claim 1, further comprising a lighting unit which lights the pattern.

8. The fixing device according to claim 1, wherein
the heated rotational body is a fixing belt.

9. The fixing device according to claim 1, wherein
the pattern includes a plurality of linear protrusions or grooves extending in an oblique direction with respect to a rotational axis direction of the heated rotational body.

10. The fixing device according to claim 1, wherein
the drive control part controls the drive unit based on the variation in the rotational speed of the heated rotational body, and then the pressing control part controls the pressing mechanism based on the meandering state of the heated rotational body to relatively change the pressing forces applied to the end portions of the pressing rotational body.

11. An image forming apparatus comprising:
the fixing device according to claim 1; and
an image forming section which forms the unfixed toner image on the recording medium which conveyed to the fixing device.
